(19) United States
(12) Patent Application Publication
(10) Pub. No.: US 2026/0352600 A1
(43) Pub. Date: Nov. 5, 2026

(54) Managing Deep Packet Inspection (DPI) Flows in a Software-Defined Wide Area Network (SD-WAN)

(71) Applicant: Arista Networks, Inc., Santa Clara, CA (US)

(72) Inventors: J Eric MOWAT, Piedmont, CA (US); Vidya KIRUPANIDHI, Santa Clara, CA (US); Venkitraman KASIVISWANATHAN, San Ramon, CA (US)

(21) Appl. No.: 19/195,588

(22) Filed: Apr. 30, 2025

(51) Int. Cl. H04L 47/2441; H04L 12/46; H04L 69/22

(52) U.S. Cl. CPC H04L 47/2441; H04L 12/4633; H04L 69/22

(57) ABSTRACT

Techniques for managing deep packet inspection (DPI) flows in a software-defined wide area network (SD-WAN) are provided. In one set of embodiments, these techniques ensure that DPI processing of a DPI flow (in both the forward and reverse directions) is performed solely by a single edge router in scenarios where the SD-WAN employs a high-availability (HA) edge router configuration at one or more sites. In another set of embodiments, these techniques ensure that updated WAN path information for a DPI flow is communicated from a source edge router (i.e., an edge router at the source site of the flow) to a destination edge router (i.e., an edge router at the destination site of the flow) in scenarios where no flow data packets are sent in the forward direction after the source edge router determines the DPI classification result, and thus the optimal WAN path, for the flow.

### BACKGROUND

A software-defined wide area network (SD-WAN) is a type of wide area network (WAN) that interconnects multiple geographically dispersed computing sites (e.g., data centers, branch offices, etc.) and employs software-defined networking to manage and optimize the transmission of WAN traffic between the sites. Each site includes one or more edge network devices, known as edge routers, that are connected to hosts residing in that site's local area network (LAN) and to edge routers at other (i.e., remote) sites. The edge routers at two different sites are generally connected to each other via multiple WAN paths, such as multiple overlay tunnels.

At the time an edge router receives, from a host in its LAN, an initial packet in a network flow that is destined for a host at a remote site, the edge router typically performs deep packet inspection (DPI) on that packet in order to classify the flow as belonging to a particular type of software application (e.g., a voice over Internet Protocol (VoIP) application, a web browser, etc.). This classification process often requires the edge router to perform DPI on multiple packets of the network flow in both the forward (i.e., LAN-to-WAN) and reverse (i.e., WAN-to-LAN) directions. Upon successfully classifying the network flow using DPI, the edge router selects an optimal path for routing the flow over the WAN in accordance with an application-aware routing policy. From that point forward, all forward and reverse traffic for the network flow should be routed using the optimal WAN path.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example SD-WAN in accordance with certain embodiments of the present disclosure.

FIG. 2 depicts an example scenario in the SD-WAN of FIG. 1 in accordance with certain embodiments of the present disclosure.

FIG. 3 depicts a LAN-to-WAN data packet processing workflow in accordance with certain embodiments of the present disclosure.

FIG. 4 depicts WAN-to-LAN data packet processing workflow in accordance with certain embodiments of the present disclosure.

FIG. 5 depicts an HA protocol packet processing workflow in accordance with certain embodiments of the present disclosure.

FIG. 6 depicts a workflow for handling flow classification completion in accordance with certain embodiments of the present disclosure.

FIG. 7 depicts a flow synchronization workflow in accordance with certain embodiments of the present disclosure.

FIG. 8 depicts a workflow for communicating updated WAN path information from a source edge router to a destination edge router in accordance with certain embodiments of the present disclosure.

FIG. 9 depicts an example edge router in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to the management of DPI flows (i.e., network flows that are classified using DPI) in an SD-WAN, and more particularly to techniques for addressing problems that may arise with respect to such flows in certain scenarios.

According to a first set of embodiments (described in section (1) below), the techniques of the present disclosure ensure that DPI processing of a DPI flow (in both the forward and reverse directions) is performed solely by a single edge router in scenarios where the SD-WAN employs a high-availability (HA) edge router configuration at one or more sites. According to a second set of embodiments (described in section (2) below), the techniques of the present disclosure ensure that updated WAN path information for a DPI flow is communicated from a source edge router (i.e., an edge router at the source site of the flow) to a destination edge router (i.e., an edge router at the destination site of the flow) in scenarios where no flow data packets are sent in the forward direction after the source edge router determines the DPI classification result, and thus the optimal WAN path, for the flow.

### 1. Ensuring DPI Flows are Processed by a Single Edge Router in HA Edge Router Configurations

Some SD-WANs employ an HA edge router configuration at one or more sites, which means there are at least two edge routers at each such site that are directly connected to each other via a peer link and are configured to operate as HA peers. Each HA peer is active at the same time and receives and processes a portion of the network traffic in the LAN-to-WAN and WAN-to-LAN directions for that site (via, e.g., Equal Cost Multi-Path Routing (ECMP)). This achieves load balancing and allows for failover protection in case one HA peer fails.

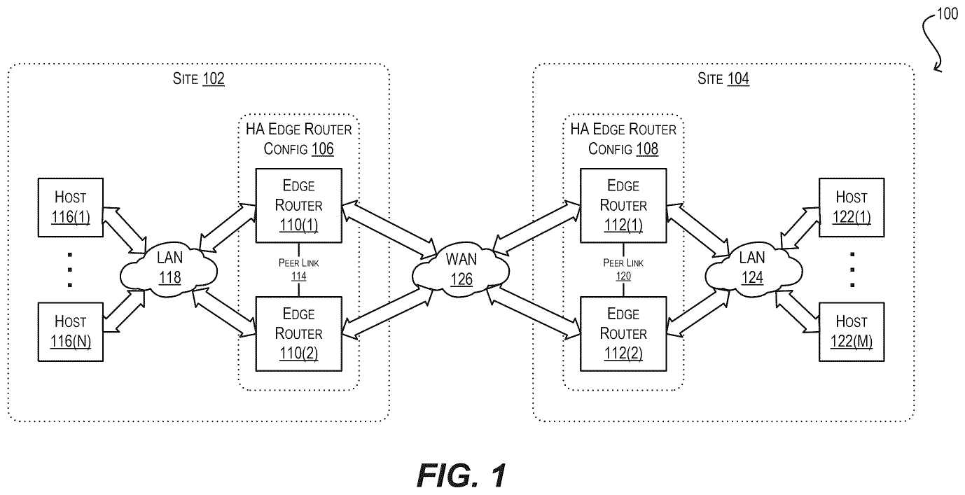

By way of example, FIG. 1 depicts a simplified block diagram of an SD-WAN 100 including two computing sites 102 and 104 where each site 102/104 implements an HA edge router configuration 106/108 comprising two edge routers that are configured as HA peers (i.e., edge routers 110(1) and 110(2) in HA edge router configuration 106 and edge routers 112(1) and 112(2) in HA edge router configuration 108). As shown, edge routers 110(1) and 110(2) are connected to each other via a peer link 114 and to a number of host devices (hosts) 116(1)-(N) at site 102 via a LAN 118. Similarly, edge routers 112(1) and 112(2) are connected to each other via a peer link 120 and to a number of host devices (hosts) 122(1)-(M) at site 104 via a LAN 124.

In addition, edge routers 110(1) and 110(2) at site 102 are communicatively coupled with edge routers 112(1) and 112(2) at site 104 via a WAN 126. Although not explicitly shown, the connectivity between these edge routers takes the form of multiple distinct paths over WAN 126. For instance, edge router 110(1) may be capable of exchanging network traffic with edge router 112(1) over three different WAN paths. These different WAN paths typically correspond to different overlay tunnels, each of which traverses a particular underlying transport type (e.g., a Multiprotocol Label Switching (MPLS) transport, an Internet-based transport, etc.) in WAN 126.

As noted in the Background section, an edge router that receives an initial packet in a network flow often needs to perform DPI on both the forward and reverse traffic of the flow in order to successfully classify it (where DPI refers to inspecting/analyzing the contents of a packet's payload, rather than simply the packet's header). This requirement is problematic if the edge router is part of an HA edge router configuration like the edge routers depicted in FIG. 1 because it is possible that some of the forward and/or reverse traffic of the flow is sent to an HA peer of the edge router rather than to the edge router itself. A known solution for this problem is to statically assign ownership of each network flow to a single edge router/HA peer in an HA edge router configuration (using, e.g., a hash function). With these static owner assignments in place, if a flow is received at an HA peer that is not the flow's owner, that non-owner HA peer will forward the flow to the owner HA peer over the peer link interconnecting the peers for both DPI processing and routing.

However, this solution suffers from its own issues. For example, once the owner HA peer has finished its DPI processing and classification of a network flow (which typically only requires looking at a subset of data packets at the beginning of the flow), it has no need to receive further data packets in the flow from the non-owner HA peer. But, because the non-owner HA peer has no visibility into the status or results of the DPI processing performed by the owner HA peer, the non-owner HA peer will continue to forward any data packets it receives for the flow to the owner HA peer, which adds extra latency for routing the flow throughout the flow's lifetime.

Further, if the owner HA peer encounters an error in routing a data packet of the flow that was forwarded by the non-owner HA peer, the owner peer will send the data packet back to the non-owner HA peer for handling. This “ping pong” effect (where the data packet traverses from the non-owner to the owner and then back to the non-owner) results in unnecessarily high utilization of the peer link.

To address the foregoing and other similar problems, the present disclosure provides a framework, referred to as the HA protocol framework, that ensures both the forward and reverse traffic of a network flow are DPI processed by a single edge router/HA peer in an HA edge router configuration while avoiding the issues of static owner assignment. At a high level, the HA protocol framework achieves this by separating DPI processing from routing (such that a network flow is DPI processed by a single HA peer but can be routed by any HA peer) and by efficiently signaling information pertaining to DPI processing and WAN path selection between the HA peers via a new control protocol, referred to as the HA protocol.

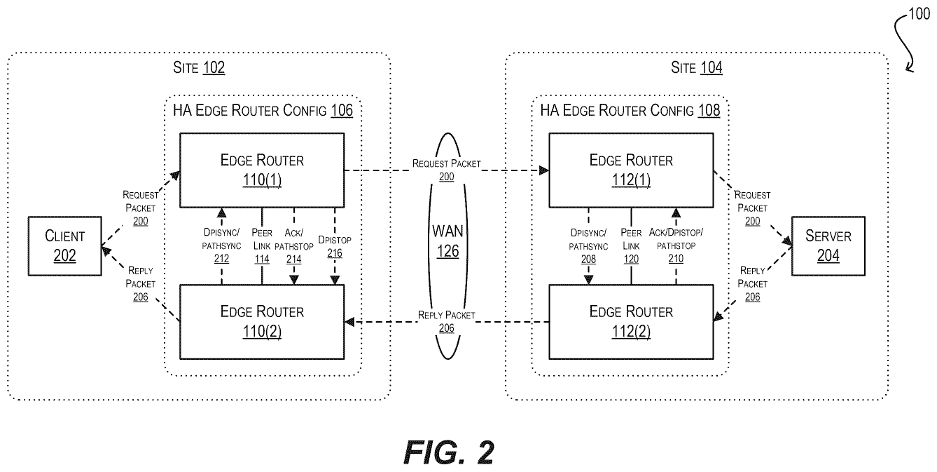

To provide context for how the HA protocol framework works, FIG. 2 depicts an example scenario with respect to SD-WAN 100 of FIG. 1 in which a first (e.g., request) data packet 200 of a network flow F is sent in a forward direction from a client 202 at site 102 to a server 204 at site 104 through edge routers 110(1) and 112(1) and a second (e.g., reply) data packet 206 of flow F is sent in a reverse direction from server 204 to client 202 through edge routers 112(2) and 110(2). This is a “worst-case” scenario in terms of managing DPI processing of flow F because the edge routers handling the forward flow traversal are completely different from the edge routers handling the reverse flow traversal, which requires a mechanism to ensure that a single edge router performs DPI processing of F in both the forward and reverse directions. Edge routers 110(1) and 110(2) are referred to as “source edge routers” in FIG. 2 because they reside at the source site that flow F originates from (i.e., site 102) and edge routers 112(1) and 112(2) are referred to as “destination edge routers” because they reside at the destination site that F is destined for (i.e., site 104).

With the HA protocol framework implemented at edge routers 110(1)-(4), the following sequence of events will occur in the scenario of FIG. 2 according to certain embodiments:
1. Source edge router 110(1) at site 102 receives request packet 200 of flow F from client 202 on a LAN interface and determines that it has not seen flow F before because this is the initial packet in the flow. In response, source edge router 110(1) creates a new entry in a local flow database, referred to as a flow cache, that identifies flow F and includes DPI state information indicating that source edge router 110(1) is the “DPI owner” of F (which means source edge router 110(1) is the singular edge router in SD-WAN 100 that will perform DPI on F in both the forward and reverse directions). This DPI state information will also eventually hold the determined classification of flow F, once the classification process is complete. Source edge router 110(1) then performs DPI on request packet 200 and routes the packet over a default WAN path to site 104 (this assumes that flow F cannot be classified solely based on the DPI performed on packet 200, although certain types of network flows, as well as network flows that were previously seen and cached by source edge router 110(1), can be classified based on the initial packet alone).
2. Destination edge router 112(1) at site 104 receives request packet 200 on a WAN interface and determines that it has not seen flow F before (because there is no entry for F in its flow cache) and it is not the flow's DPI owner (because it is seeing F for the first time on a WAN, rather than LAN, interface). In response, destination edge router 112(1) creates a new entry for flow F in its flow cache that includes path information specifying the current WAN path for F (as included in the path/tunnel header of request packet 200). This allows destination edge router 112(1) to route packets of flow F in the reverse direction (i.e., towards site 102) using that same WAN path. In addition, destination edge router 112(1) constructs and sends an HA protocol packet to its HA peer (i.e., destination edge router 112(2)) over peer link 120, where the HA protocol packet encapsulates request packet 200 within an HA protocol header that has a “DPISYNC” indicator enabled (thereby signaling a DPISYNC message) and a “PATHSYNC” indicator enabled (thereby signaling a PATHSYNC message). This HA protocol packet, referred to as a DPISYNC/PATHSYNC packet and shown via reference numeral 208, provides (or in other words, synchronizes) information from destination edge router 112(1) to destination edge router 112(2) that the latter can use to perform DPI on packet 200 (if destination edge router 112(2) is the DPI owner of flow F) and/or record the current WAN path for routing packets of F in the reverse direction (if destination edge router 112(2) is not the DPI owner of F).
3. Destination edge router 112(2) receives DPISYNC/PATHSYNC packet 208 from destination edge router 112(1) on a peer link interface and determines that it has not seen flow F before (because there is no entry for F in its flow cache) and it is not the flow's DPI owner (because it is seeing F for the first time on a peer link, rather than LAN, interface). In response, destination edge router 112(2) creates a new entry for flow F in its flow cache that includes path information specifying F's current WAN path (as included in the tunnel/path header of inner request packet 200). Destination edge router 112(2) also constructs and sends an HA control packet to destination edge router 112(1) over peer link 120, where the HA protocol packet encapsulates request packet 200 within an HA protocol header that has an “ACK” indicator enabled (thereby signaling an ACK message), a “DPISTOP” indicator enabled (thereby signaling a DPISTOP message), and a “PATHSTOP” indicator enabled (thereby signaling a PATHSTOP message). This HA protocol packet, referred to as an ACK/DPISTOP/PATHSTOP packet and shown via reference numeral 210, informs destination edge router 112(1) that destination edge router 112(2) acknowledges receipt of the DPISYNC message signaled in DPISYNC/PATHSYNC packet 208 (per the signaled ACK message), destination edge router 112(1) should not signal any further DPISYNC messages for flow F to destination edge router 112(2) (per the signaled DPISTOP message), and destination edge router 112(1) should not signal any further PATHSYNC messages for F to destination edge router 112(2) unless F's associated WAN path changes (per the signaled PATHSTOP message). Upon receiving ACK/DPISTOP/PATHSTOP packet 210, destination edge router 112(1) updates its flow cache entry for flow F in order to indicate that no further DPISYNC and PATHSYNC messages should be signaled for this flow. In addition, destination edge router 112(1) forwards the inner packet in ACK/DPISTOP/PATHSTOP packet 210 (i.e., original request packet 200) to server 204 at site 104.
4. At some later point in time, destination edge router 112(2) receives reply packet 206 of flow F from server 204 on a LAN interface and determines that it has seen F before (because there is an entry for F in its flow cache) and it is not the flow's DPI owner (because there is no DPI state information in the flow cache entry). In response, destination edge router 112(2) skips DPI processing of reply packet 206, retrieves the WAN path specified in the path information of the flow cache entry, and routes reply packet 206 over that WAN path to site 102.
5. Source edge router 110(2) at site 102 receives reply packet 206 on a WAN interface and determines that it has not seen flow F before (because there is no entry for F in its flow cache) and it not the flow's DPI owner (because it is seeing F for the first time on a WAN, rather than LAN, interface). In response, source edge router 110(2) creates a new entry for flow F in its flow cache that includes path information specifying the current WAN path for F (as included in the path/tunnel header of reply packet 206). This allows source edge router 110(2) to route packets of flow F in the forward direction (i.e., towards site 104) using that same WAN path. In addition, source edge router 110(2) constructs and sends a DPISYNC/PATHSYNC packet 212 to its HA peer (i.e., source edge router 110(1)) over peer link 114, where packet 212 encapsulates reply packet 206 within an HA protocol header that has the DPISYNC indicator enabled (thereby signaling a DPISYNC message) and the PATHSYNC indicator enabled (signaling a PATHSYNC message). Like DPISYNC/PATHSYNC packet 208 mentioned previously, DPISYNC/PATHSYNC packet 212 provides/synchronizes information from source edge router 110(2) to source edge router 110(1) that the latter can use to perform DPI on reply packet 206 (if source edge router 112(1) is the DPI owner of flow F) and/or record the current WAN path for routing packets of F in the forward direction (if source edge router 112(1) is not the DPI owner of F).
6. Source edge router 110(1) receives DPISYNC/PATHSYNC packet 212 from source edge router 110(2) on a peer link interface and determines that it has seen flow F before (because there is an existing entry for F in its flow cache) and it is the flow's DPI owner (because the flow cache entry includes DPI state information). In response, source edge router 110(1) performs DPI on the inner packet in DPISYNC/PATHSYNC packet 212 (i.e., reply packet 206). In addition, assuming classification of flow F is still not complete at this point, source edge router 110(1) constructs and sends an HA control packet to source edge router 110(2) over peer link 114, where the HA protocol packet encapsulates reply packet 206 within an HA protocol header that has the ACK indicator enabled (thereby signaling an ACK message) and the PATHSTOP indicator enabled (thereby signaling a PATHSTOP message). This HA protocol packet, referred to as an ACK/PATHSTOP packet and shown via reference numeral 214, informs source edge router 110(2) that source edge router 110(1) acknowledges receipt of the DPISYNC message signaled in DPISYNC/PATHSYNC packet 212 (per the signaled ACK message) and source edge router 110(2) should not signal any further PATHSYNC messages for flow F to source edge router 110(1) unless F's associated WAN path changes (per the signaled PATHSTOP message). Upon receiving ACK/PATHSTOP packet 214, source edge router 110(2) updates its flow cache entry for flow F in order to indicate that no further PATHSYNC messages should be signaled for this flow. Source edge router 110(2) then forwards the inner packet in the HA protocol packet (i.e., original reply packet 206) to client 202 at site 102.
7. Once source edge router 110(1) determines that classification of flow F is complete (which may occur upon performing DPI on any packet of F), it carries out two actions: (A) it constructs and sends another HA protocol packet to source edge router 110(2) over peer link 114 that includes information identifying flow F (e.g., the flow's 5-tuple) in its payload and has the DPISTOP indicator enabled in its header, and (B) it selects an optimal WAN path for F based on the classification result and a routing policy, such that all forward traffic received by source edge router 110(1) for F from that point onward is forwarded over the optimal WAN path. With respect to action (A), the transmitted HA protocol packet (referred to as a DPISTOP packet and shown via reference numeral 216) informs source edge router 110(2) that it should not signal any further DPISYNC messages for flow F to source edge router 110(1) because they are no longer needed. Upon receiving DPISTOP packet 216, source edge router 110(2) updates its flow cache entry for flow F in order to indicate that no further DPISYNC messages should be signaled for this flow.
8. With respect to action (B), assume source edge router 110(2) subsequently receives a second reply packet of flow F from either destination edge router 112(2) or 112(1) over the selected optimal WAN path (which is different from the default WAN path used for original packets 200 and 206). In this scenario (which is not depicted in FIG. 2), source edge router 110(2) will send an HA protocol packet to source edge router 110(1) that encapsulates a copy of the reply packet and has the PATHSYNC indicator enabled in its header (i.e., a PATHSYNC packet), as well as concurrently forward the reply packet to its destination (i.e., client 202 at site 102). Upon receiving this PATHSYNC packet, source edge router 110(1) will respond with a PATHSTOP packet. There is no ACK message signaled by source edge router 110(1) in this scenario because ACK messages are only used for acknowledging DPISYNC messages.

With the processing and packet exchanges described above, the HA protocol framework advantageously ensures that only a single edge router performs DPI on the data packets of a network flow, despite the presence of HA edge router configurations at the source and/or destination sites of the flow. In addition, the framework decouples DPI processing from routing and allows the DPI owner of a network flow to signal to its HA peer(s) that its DPI processing/classification of the flow is complete, thereby avoiding the problems of static ownership assignment.

It should be noted that the purpose of the ACK messages in the HA protocol framework (which are only signaled in response to DPISYNC messages) is to prevent potential race conditions. For example, assume that at step (2) above, destination edge router 112(1) forwards request packet 200 to server 204 at site 104 concurrently with sending DPISYNC/PATHSYNC packet 208 over peer link 120 to destination edge router 112(2). In this case, it is possible that destination edge router 112(2) receives reply packet 206 in the reverse direction from server 204 before it receives DPISYNC/PATHSYNC packet 208 from destination edge router 112(1), which will cause destination edge router 112(2) to erroneously determine that it should be the DPI owner for flow F.

Similarly, assume that at step (5) above, source edge router 110(2) forwards reply packet 206 to client 202 at site 102 concurrently with sending DPISYNC/PATHSYNC packet 212 over peer link 114 to source edge router 110(1). In this case, it is possible that source edge router 110(1) receives a new request packet in the forward direction of flow F from client 202 before it receives DPISYNC/PATHSYNC packet 212 from source edge router 110(2), which will cause source edge router 110(1) to perform DPI out of order on F (i.e., on the new request packet before reply packet 206). Such out-of-order DPI processing can result in an erroneous flow classification. The ACK mechanism avoids both of these issues by ensuring that destination edge router 112(1)/source edge router 110(2) only forwards packet 200/206 onward after receiving an ACK message from its HA peer (i.e., destination edge router 112(2)/source edge router 110(1)).

### 1.1 Example Implementation

The following sub-sections present a set of workflows that may be executed by each edge router in an SD-WAN topology comprising one or more HA edge router configurations (like SD-WAN 100 of FIGS. 1 and 2) for implementing the HA protocol framework according to certain embodiments. These workflows may be carried out via software, hardware, or a combination of software and hardware that runs within and/or is part of the data plane of the edge router.

### 1.1.1 LAN-to-WAN Data Packet Processing

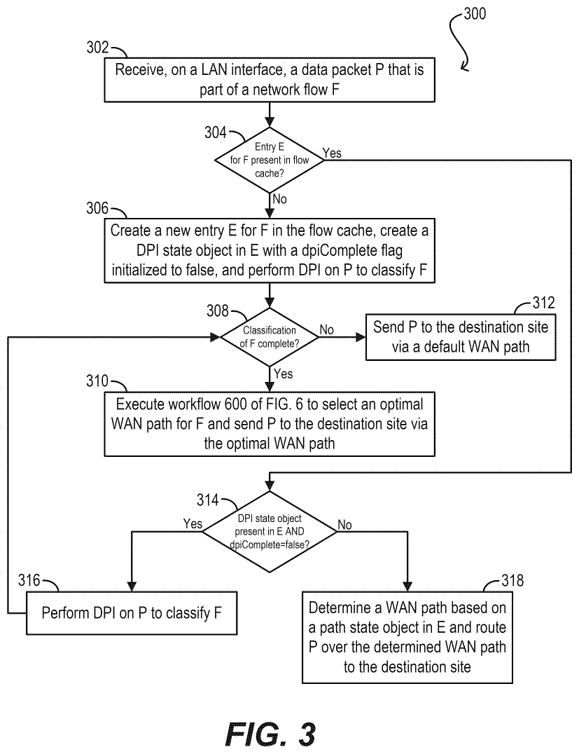

FIG. 3 depicts an HA protocol framework workflow 300 that may be executed by an edge router with respect to data packets received on LAN interfaces of the device (or in other words, data packets traveling in the LAN-to-WAN direction).

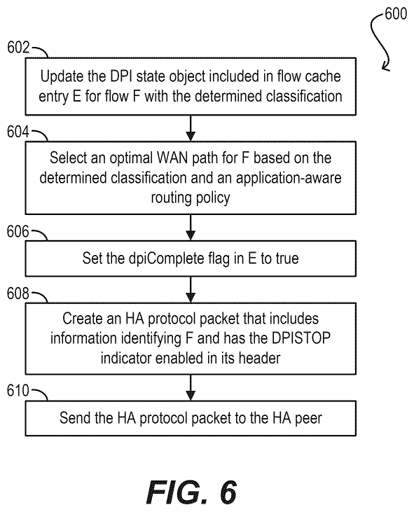

Starting with steps 302 and 304, the edge router can receive a data packet P that is part of a network flow F on a LAN interface and can check whether an entry E for flow F is present in the edge router's flow cache. If the answer is no (which means the edge router has not seen/received flow F before), the edge router can create a new entry E in the flow cache that identifies F (e.g., includes the 5-tuple of F), create a DPI state object in entry E with a “dpiComplete” flag initialized to false, and perform DPI on packet P in order to classify F (step 306). The edge router can then check whether the classification of flow F is now complete (step 308). If so, the edge router can execute workflow 600 of FIG. 6 (described below) to select an optimal WAN path for flow F and can send packet P over the optimal WAN path to the packet's destination (step 310). Otherwise, the edge router can send packet P over a default WAN path to the packet's destination site (step 312).

If the answer at step 304 is yes (which means the edge router has seen flow F before), the edge router can further check whether a DPI state object is present in existing entry E AND the dpiComplete flag is set to false (step 314). If so (which means the edge router is the DPI owner of flow F), the edge router can perform DPI on packet P in order to classify F (step 316) and return to step 308. If not, the edge router can determine a WAN path for routing packet P based on a path state object in existing entry E and can route P over the determined WAN path to the destination site (block 318).

### 1.1.2 WAN-to-LAN Data Packet Processing

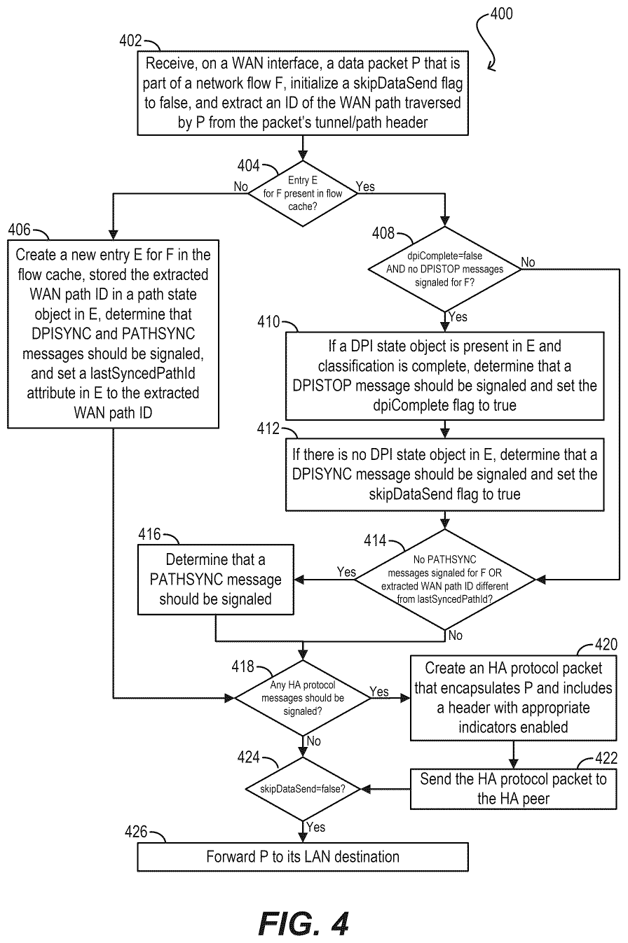

FIG. 4 depicts an HA protocol framework workflow 400 that may be executed by an edge router with respect to data packets received on WAN interfaces of the device (or in other words, data packets traveling in the WAN-to-LAN direction).

Starting with step 402, the edge router can receive a data packet P that is part of a network flow F on a WAN interface, initialize a “skipDataSend” flag to false, and extract an identifier (ID) of the WAN path traversed by P from the packet's tunnel/path header. The edge router can then check whether an entry E for flow F is present in the edge router's flow cache (step 404).

If the answer is no (which means the edge router has not seen/received flow F before), the edge router can create a new entry E in the flow cache that identifies F, store the extracted WAN path ID in a path state object in E, determine that DPISYNC and PATHSYNC messages should be signaled, and set a “lastSyncedPathId” attribute in E to the extracted WAN path ID (step 406).

If the answer at step 404 is yes, the edge router can check whether the dpiComplete flag in existing entry E is set to false AND no DPISTOP messages have been signaled for flow F (step 408). If so, the edge router can determine that a DPISTOP message should be signaled and can set the dpiComplete flag to true (if a DPI state object is present in E and classification is complete) (step 410), or determine that a DPISYNC message should be signaled and can set the skipDataSend flag to true (if there is no DPI state object in E) (step 412).

At step 414, the edge router can further check whether no PATHSYNC messages have been signaled for flow F OR the extracted WAN path ID is different from the lastSyncedPathId attribute. If so, the edge router can determine that a PATHSYNC message should be signaled (step 416).

Turning now to step 418, the edge router can check whether it has determined that any HA protocol messages should be signaled per the foregoing steps. If the answer is yes, the edge router can create an HA protocol packet that encapsulates packet P and includes an HA protocol header with appropriate indicators enabled per the determined messages (step 420). The edge router can then send the HA protocol packet over a peer link to the edge router's HA peer (step 422).

Finally, if the skipDataSend flag is set to false, the edge router can forward packet P to its LAN destination (steps 424 and 426).

### 1.1.3 HA Protocol Packet Processing

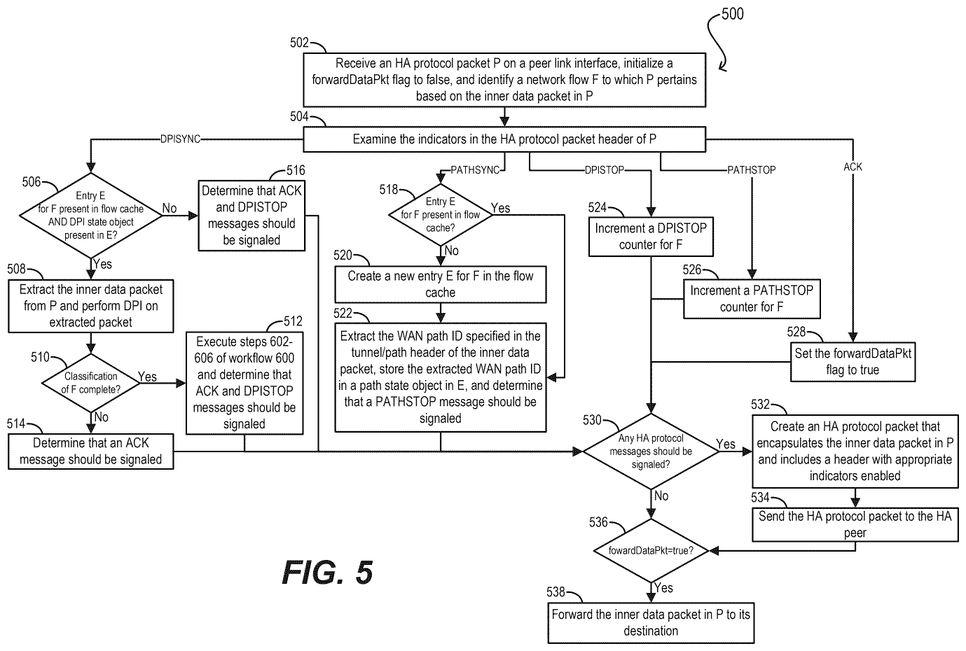

FIG. 5 depicts an HA protocol framework workflow 500 that may be executed by an edge router with respect to HA protocol packets received on a peer link interface of the device.

Starting with step 502, the edge router can receive an HA protocol packet P on a peer link interface from an HA peer, initialize a “forwardDataPkt” flag to false, and determine a network flow F to which P pertains based on the inner data packet included in the payload of P. The edge router can then examine the indicators in the HA protocol header of packet P (step 504).

If the DPISYNC indicator is enabled in packet P's header, the edge router can check whether an entry E for flow F is present in its flow cache AND a DPI state object is present in E (step 506). If the answer is yes, the edge router can extract the inner data packet from P's payload and can perform DPI on the extracted data packet (step 508). The edge router can further check whether classification of flow F is now complete (step 510); if so, the edge router can execute steps 602-606 of workflow 600 of FIG. 6 and determine that ACK and DPISTOP messages should be signaled (step 512). If not, the edge router can determine that an ACK message should be signaled (step 514).

If the answer at step 506 is no, the edge router can determine that an ACK message and a DPISTOP message should be signaled (step 516).

If the PATHSYNC indicator is enabled in packet P's header, the edge router can check whether an entry E for flow F is present in its flow cache (step 518). If not, the edge router can create a new entry E for flow F that identifies F (step 520). The edge router can then extract the WAN path ID specified in the tunnel/path header of the inner data packet, store the extracted WAN path ID in a path state object in E, and determine that a PATHSTOP message should be signaled (step 522).

If the DPISTOP indicator is enabled in packet P's header, the edge router can increment a DPISTOP message counter for flow F (step 524).

If the PATHSTOP indicator is enabled in packet P's header, the edge router can increment a PATHSTOP message counter for flow F (step 526).

If the ACK indicator is enabled in packet P's header, the edge router can set the forwardDataPkt flag to true (step 528).

Turning now to step 530, the edge router can check whether it has determined that any HA protocol messages should be signaled per the foregoing steps. If the answer is yes, the edge router can create an HA protocol packet that encapsulates the inner data packet in packet P and includes an HA protocol header with appropriate indicators enabled per the determined messages (step 532). The edge router can then send the HA protocol packet over the peer link to the HA peer (step 534).

Otherwise, the edge router can check whether the forwardDataPkt flag is set to true (step 536); if so, the edge router can forward the inner data packet in packet P to its destination (step 538).

### 1.1.4 Handling Classification Completion

FIG. 6 depicts an HA protocol framework workflow 600 that may be executed by an edge router in response to determining that its classification of a network flow F is complete.

Starting with step 602, the edge router can update the DPI state object included in the entry for flow F in its flow cache with the determined classification.

At step 604, the edge router can select an optimal WAN path for flow F based on the determined classification and an application-aware routing policy and can update the path state object in the flow cache entry for flow F with the selected optimal WAN path.

At step 606, the edge router can set the dpiComplete flag in the flow cache entry for flow F to true.

At step 608, the edge router can create an HA protocol packet that includes information identifying flow F (e.g., F's 5-tuple) in the packet's payload and has the DPISTOP indicator enabled in the packet's HA protocol header (in certain embodiments, the ACK indicator will also be enabled if the classification was performed in response to receiving a DPISYNC message from the HA peer).

Finally, at step 610, the edge router can send the HA protocol packet over the peer link to its HA peer.

### 1.2 Flow Synchronization

In a failure scenario where one edge router/HA peer in an HA edge router configuration goes down, it would be useful for the DPI state and path state information held in that failed edge router's flow cache (for the network flows it is DPI owner of) to be made available to the other, operational HA peer. This allows the operational HA peer to take over DPI processing of those flows without having to rebuild their associated DPI and/or path state.

To achieve this, in some embodiments the HA protocol framework also includes a new flow synchronization protocol (separate from the HA protocol) that is carried out by the edge routers in an HA edge router configuration. This flow synchronization protocol assumes each edge router maintains an additional “dpiOwner” flag for each entry in its flow cache that is set to true for entries/flows that are owned by the edge router.

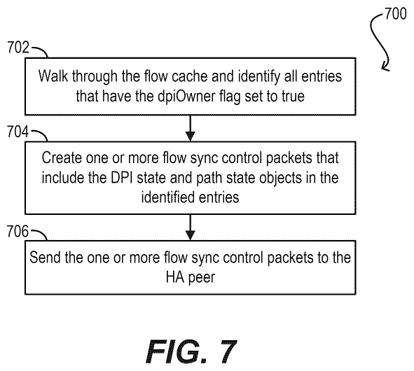

FIG. 7 depicts a workflow 700 that can be executed by an edge router for implementing the flow synchronization protocol according to certain embodiments. Workflow 700 can be repeated on a periodic basis, such as every X seconds.

Starting with step 702, the edge router can walk through its flow cache and identify all entries in the flow cache that have the dpiOwner flag set to true.

At step 704, the edge router can create one or more “flow sync” control packets that include the DPI state and path state objects in the identified entries.

Finally, at step 706, the edge router can send the one or more flow sync control packets over the peer link to its HA peer. Upon receiving these packets, the HA peer can update its flow cache with the DPI state and path state objects included in the packets for the identified entries, thereby making that information locally available to the HA peer (for use in a scenario where the edge router that sent the flow sync control packets fails).

### 2. Ensuring Updated WAN Information is Communicated to a Destination Edge Router

In SD-WANs that employ HA or non-HA edge router configurations, when a source edge router at a source site classifies and selects an optimal WAN path for a network flow, the source edge router typically conveys an ID of the selected path to a destination edge router at a destination site via the tunnel/path headers of the flow's forward data packets (i.e., the data packets sent from a client at the source site to a server at the destination site). However, for some types of network flows, after the initial client-server connection is established, data packets are only sent in the reverse direction from the server to the client. This means that once a source edge router has classified the flow and selected an optimal WAN path, there is no way for the source edge router to signal this optimal WAN path to the destination edge router. As a result, the destination edge router will continue to use a default WAN path for the flow that was determined by the source edge router prior to flow classification, which is undesirable.

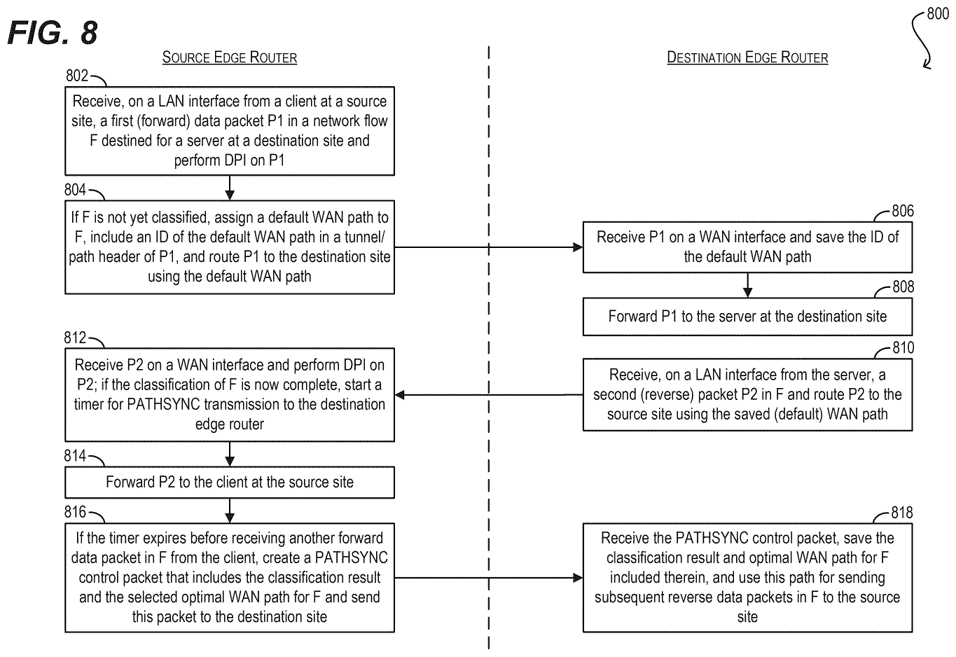

To address this and other similar problems, the present disclosure provides techniques for conveying WAN path information from a source edge router to a destination edge router via a special control packet that is similar to the PATHSYNC packet described in the foregoing sections. FIG. 8 depicts a workflow 800 for implementing these techniques in accordance with certain embodiments. In an SD-WAN that employs HA edge router configurations like SD-WAN 100 of FIGS. 1 and 2, the source edge router of workflow 800 may be an HA peer at the source site and the destination edge router of workflow 800 may be an HA peer at the destination site. Alternatively, in an SD-WAN that does not employ HA edge router configurations, the source edge router of workflow 800 may be a standalone edge router (i.e., non-HA peer) at the source site and the destination edge router of workflow 800 may be a standalone edge router (i.e., non-HA peer) at the destination site.

Starting with step 802, a source edge router can receive, on a LAN interface from a client at a source site, a first (forward) data packet P1 in a network flow F destined for a server at a destination site and can perform DPI on packet P1 (because the source edge router is the first edge router to see/receive this flow). If flow F can be classified via the DPI performed on packet P1, the source edge router can select an optimal WAN path for F based on the determined classification (not shown). Otherwise, the source edge router can assign a default WAN path to flow F, include an ID of the default WAN path in a tunnel/path header of packet P1, and route P1 over the WAN to the destination site using the default WAN path (step 804).

At step 806, the destination edge router can receive packet P1 on a WAN interface and can save the ID of the default WAN path traversed by P1 (as specified in the packet's tunnel/path header). The destination edge router can then forward packet P1 to the server at the destination site (step 808).

At some later point in time, the destination edge router can receive, on a LAN interface from the server at the destination site, a second (reverse) data packet P2 in flow F destined for the client at the source site and can route packet P2 over the WAN to the source site via the saved (default) WAN path for F (step 810).

At step 812, the source edge router can receive packet P2 on a WAN interface and can perform DPI on P2. If classification of flow F is complete at this point, the source edge router can start a timer for PATHSYNC transmission to the destination edge router. The source edge router can then forward packet P2 to the client at the source site (step 814).

If the timer expires before the source edge router receives another forward data packet in flow F from the client, the source edge router can create a PATHSYNC control packet that includes the classification result and the selected optimal WAN path for F and can send the PATHSYNC control packet to the destination site (step 816).

Finally, at step 818, the destination edge router can receive the PATHSYNC control packet and save the classification result and optimal WAN path for flow F included therein. This will cause the destination edge router to use that optimal WAN path for sending subsequent reverse data packets in flow F to the source site.

Although not shown in workflow 800, in some embodiments the source edge router can verify whether the destination edge router is in fact sending subsequent reverse packets in flow F over the optimal WAN path by checking the tunnel/path headers of those packets. If the source edge router determines via this verification process that the destination edge router is not using the optimal WAN path, it can resend the PATHSYNC control packet to the destination edge router after some time interval. The source edge router can thereafter repeat the verification and resend actions until the destination edge router correctly switches over to using the optimal WAN path.

According to one set of embodiments, a method performed by a source edge router in a software-defined wide area network (SD-WAN) is provided, wherein the source edge router resides at a first site of the SD-WAN, and wherein the method comprises receiving, from a destination edge router at a second site of the SD-WAN remote from the first site, a reverse data packet of a network flow, wherein the reverse data packet originated from a server at the second site, wherein the reverse data packet is destined for a client at the first site, and wherein the reverse data packet was sent by the server in response to an initial forward data packet of the network flow sent by the client; performing deep packet inspection (DPI) on the reverse data packet; and in response to determining that classification of the network flow is complete, selecting a WAN path for the network flow and starting a timer.

In certain embodiments, the selected WAN path is an optimal WAN path for the network flow that is selected based on a determined classification of the network flow and an application-aware routing policy.

In certain embodiments, the client does not send out any further forward data packets after the initial forward data packet.

In certain embodiments, the method further comprises forwarding the reverse data packet to the client at the first site.

In certain embodiments, the method further comprises, upon determining that the timer has expired without receiving another forward data packet of the network flow from the client, sending a control packet to the destination edge router, the control packet including a determined classification and the selected WAN path for the network flow.

In certain embodiments, upon receiving the control packet, the destination edge router saves the determined classification and the selected WAN path for the network flow and transmits further reverse data packets of the network flow to the source edge router using the selected WAN path.

In certain embodiments, the method further comprises receiving a further reverse data packet of the network flow from the destination edge router and verifying whether the further reverse data packet was sent using the selected WAN path.

In certain embodiments, the verifying is performed by checking a tunnel or path header of the further reverse data packet.

In certain embodiments, the method further comprises, upon determining that the further reverse data packet was not sent using the selected WAN path, resending the control packet to the destination edge router.

In certain embodiments, the method further comprises repeating the verifying and the resending until the destination edge router has switched over to using the selected WAN path.

According to another set of embodiments, a network device operating as a source edge router in a software-defined wide area network (SD-WAN) is provided, where the source edge router resides at a first site of the SD-WAN. The network device comprises a control plane and a data plane. The data plane is configured to receive, from a destination edge router at a second site of the SD-WAN remote from the first site, a reverse data packet of a network flow, wherein the reverse data packet originated from a server at the second site, wherein the reverse data packet is destined for a client at the first site, and wherein the reverse data packet was sent by the server in response to an initial forward data packet of the network flow sent by the client; perform deep packet inspection (DPI) on the reverse data packet; and in response to determining that classification of the network flow is complete: select a WAN path for the network flow and start a timer.

In certain embodiments, the data plane is further configured to forward the reverse data packet to the client at the first site.

In certain embodiments, the data plane is further configured to, upon determining that the timer has expired without receiving another forward data packet of the network flow from the client, send a control packet to the destination edge router, the control packet including a determined classification and the selected WAN path for the network flow.

In certain embodiments, the data plane is further configured to receive a further reverse data packet of the network flow from the destination edge router and verify whether the further reverse data packet was sent using the selected WAN path.

In certain embodiments, the data plane is further configured to, upon determining that the further reverse data packet was not sent using the selected WAN path, resend the control packet to the destination edge router.

In certain embodiments, the data plane is further configured to repeat the verifying and the resending until the destination edge router has switched over to using the selected WAN path.

According to yet another set of embodiments, a method performed by a destination edge router in a software-defined wide area network (SD-WAN) is provided, wherein the destination edge router resides at a destination site of the SD-WAN, and wherein the method comprises sending, to a source edge router at a source site of the SD-WAN remote from the destination site, a reverse data packet of a network flow, wherein the reverse data packet originated from a server at the destination site, wherein the reverse data packet is destined for a client at the source site, and wherein the reverse data packet is sent in response to an initial forward data packet of the network flow sent by the client; receiving, from the source edge router, a control packet that includes a determined classification and a selected WAN path for the network flow; saving the determined classification and the selected WAN path; and transmitting further reverse data packets of the network flow to the source edge router using the selected WAN path.

### 3. Example Edge Router

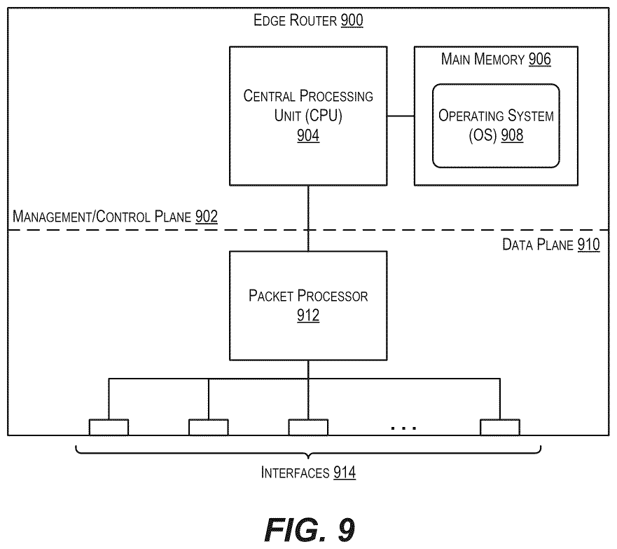

FIG. 9 is a simplified block diagram illustrating the architecture of an example edge router 900 according to certain embodiments. This architecture may be employed by any of the edge routers described in the foregoing disclosure, including edge routers 110(1)-(2) and 112(1)-(2) of SD-WAN 100.

As shown in FIG. 9, edge router 900 comprises a management/control plane 902 including a central processing unit (CPU) 904 and a main memory 906. CPU 904 is a general-purpose processor that is responsible for managing the configuration/operation of edge router 900 and controlling the device's understanding of the network in which it resides. CPU 904 carries out these functions under the direction of an operating system (OS) 908 that runs on CPU 904 from main memory 906.

Edge router 900 also comprises a data (or forwarding) plane 910 including a packet processor 912 and a set of front-panel interfaces (ports) 914. Packet processor 912 is typically an integrated circuit, such as an application-specific integrated circuit (ASIC) or a field-programmable gate array (FPGA), that is responsible for performing line-speed processing of network packets that pass through edge router 900 via interfaces 914. This line-speed processing can include, for example, Layer 2 (L2) forwarding and Layer 3 (L3) routing of network packets. In certain embodiments, some or all of the workflows described in the foregoing disclosure may be implemented as software (i.e., program code) and/or hardware that is part of data plane 910 of edge router 900.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a first edge router in a software-defined wide area network (SD-WAN), the first edge router being part of a first high-availability (HA) edge router configuration at a first site of the SD-WAN, the method comprising:
receiving a first data packet of a network flow on a local area network (LAN) interface of the first edge router, the first data packet originating from a client at the first site and being destined for a server at a second site of the SD-WAN remote from the first site;
determining whether the network flow has been previously seen by the first edge router; and
in response to determining that the network flow has not been previously seen by the first edge router:
designating the first edge router as a deep packet inspection (DPI) owner of the network flow;
performing DPI on the first data packet in order to classify the network flow; and
routing the first data packet over a wide area network (WAN) to the second site.

2. The method of claim 1 wherein the first data packet is received on WAN interface of a second edge router that is part of a second HA edge router configuration at the second site, and
wherein the second edge router:
determines whether the network flow has been previously seen by the second edge router; and
in response to determining that the network flow has not been previously seen by the second edge router:
creates a first HA protocol packet that encapsulates the first data packet and comprises an HA protocol header signaling a DPISYNC message and a PATHSYNC message; and
sends the first HA protocol packet to a third edge router over a first peer link between the second edge router and the third edge router, the third edge router being an HA peer of the second edge router in the second HA edge router configuration at the second site.

3. The method of claim 2 wherein in response to receiving the first HA protocol packet over the first peer link, the third edge router:
determines whether the network flow has been previously seen by the third edge router; and
in response to determining that the network flow has not been previously seen by the third edge router:
extracts, from the first HA protocol packet, an identifier (ID) of a WAN path traversed by the first data packet from the first site to the second site; and
stores an association between the identifier of the WAN path and the network flow.

4. The method of claim 3 wherein the third edge router further:
creates a second HA protocol packet that encapsulates the first data packet and comprises an HA protocol header that signals an ACK message, a DPISTOP message, and a PATHSTOP message; and
sends the second HA protocol packet to the second edge router over the first peer link.

5. The method of claim 4 wherein, upon receiving the second HA protocol packet, the second edge router:
stops sending HA protocol packets to the third edge router that signal a DPISYNC message or a PATHSYNC message; and
forwards the first data packet to the server at the second site.

6. The method of claim 5 wherein the third edge router receives a second data packet of the network flow on a LAN interface of the third edge router, the second data packet originating from the server at the second site and being destined for the client at the first site; and
wherein the third edge router:
determines that the third edge router has previously seen the network flow but is not the DPI owner of the network flow; and
in response to the determining:
routes the second data packet over the WAN path identified in the stored association to the first site.

7. The method of claim 6 wherein the second data packet is received on a WAN interface of a fourth edge router, the fourth edge router being an HA peer of the first edge router in the first HA edge router configuration at the first site, and
wherein the fourth edge router:
determines whether the network flow has been previously seen by the fourth edge router; and
in response to determining that the network flow has not been previously seen by the fourth edge router:
creates a third HA protocol packet that encapsulates the second data packet and comprises an HA protocol header that signals a DPISYNC message and a PATHSYNC message; and
sends the third HA protocol packet to the first edge router over a second peer link between the fourth edge router and the first edge router.

8. The method of claim 7 wherein in response to receiving the third HA protocol packet over the second peer link, the first edge router:
determines that the first edge router has previously seen the network flow and is the DPI owner of the network flow; and
in response to the determining:
extracts the second data packet from the third HA protocol packet; and
performs DPI on the second data packet.

9. The method of claim 8 wherein the first edge router further:
creates a fourth HA protocol packet that encapsulates the second data packet and comprises an HA protocol header that signals an ACK message and a PATHSTOP message; and
sends the fourth HA protocol packet to the fourth edge router over the second peer link.

10. The method of claim 9 wherein, upon receiving the fourth HA protocol packet, the fourth edge router:
stops sending HA protocol packets to the first edge router that signal a PATHSYNC message; and
forwards the second data packet to the client at the first site.

11. The method of claim 9 wherein upon determining that classification of the network flow is complete, the first edge router:
creates a fifth HA protocol packet comprising a payload that includes information identifying the network flow and an HA protocol header that signals a DPISTOP message; and
sends the fifth protocol packet to the fourth edge router over the second peer link.

12. The method of claim 11 wherein the first edge router determines that the classification of the network flow is complete in response to receiving the third HA protocol packet from the fourth edge router, and wherein the HA protocol header in the fifth HA protocol packet further includes an ACK message.

13. The method of claim 11 wherein, upon receiving the fifth HA protocol packet, the fourth edge router stops sending HA protocol packets to the first edge router that signal a DPISYNC message.

14. A network device operating as an edge router in a software-defined wide area network (SD-WAN), the edge router being part of a high-availability (HA) edge router configuration at a first site of the SD-WAN, the network device comprising:
a control plane;
a data plane configured to:
receive a first data packet of a network flow on a local area network (LAN) interface, the first data packet originating from a client at the first site and being destined for a server at a second site of the SD-WAN remote from the first site;
determine whether the network flow has been previously seen by the network device; and
in response to determining that the network flow has not been previously seen by the network device:
designate the network device as a deep packet inspection (DPI) owner of the network flow;
perform DPI on the first data packet in order to classify the network flow; and
route the first data packet over a wide area network (WAN) to the second site.

15. The network device of claim 14 wherein determining whether the network flow has been previously seen by the network device comprises:
determining whether a flow cache entry for the network flow exists in a flow cache of the network device.

16. The network device of claim 14 wherein designating the network device as the DPI owner of the network flow comprises:
creating a new flow cache entry for the network flow in the flow cache; and
creating a DPI state object in the created flow cache entry.

17. The network device of claim 14 wherein the data plane is further configured to, on a periodic basis:
walk through all flow cache entries in the flow cache;
identify a subset of the flow cache entries where the network device is the DPI owner;
create a flow sync control packet that includes DPI state objects of the subset of flow cache entries; and
send the flow sync control packet to an HA peer in the HA edge router configuration.

18. The network device of claim 17 wherein, upon receiving the flow sync control packet, the HA peer updates a local flow cache with the DPI state objects of the subset of flow cache entries.

19. A method performed by an edge router in a software-defined wide area network (SD-WAN), the edge router being part of a high-availability (HA) edge router configuration at a first site of the SD-WAN, the method comprising:
receiving a forward data packet of a network flow on a local area network (LAN) interface, wherein the forward data packet originated from a client at the first site;
performing deep packet inspection (DPI) on the forward data packet in order to classify the network flow;
routing the forward data packet over a wide area network (WAN) to a second site of the SD-WAN;
receiving a HA control packet from an HA peer in the HA edge router configuration, the HA control packet including a payload comprising a reverse data packet of the network flow and an HA protocol header that signals a DPISYNC message and a PATHSYNC message, wherein the reverse data packet originated from a server at the second site, and wherein the reverse data packet was sent by the server in response to the forward data packet;
extracting the reverse data packet from the HA protocol packet; and
performing DPI on the reverse data packet.

20. The method of claim 19 further comprising, in response to determining that classification of the network flow is complete:
selecting an optimal WAN path for the network flow;
starting a timer; and
upon determining that the timer has expired without receiving another forward data packet of the network flow from the client, sending a path synchronization control packet to the second site, the path synchronization control packet including a determined classification and the optimal WAN path for the network flow.
